(19) United States
(12) Patent Application Publication
(10) Pub. No.: US 2024/0211774 A1
(43) Pub. Date: Jun. 27, 2024

(54) GEOGRAPHIC HEAT OR COLD DISTRIBUTION MODEL

(71) Applicant: Intel Corporation, Santa Clara, CA (US)

(72) Inventors: Cornelius Buerkle, Karlsruhe (DE); Ignacio Alvarez, Portland, OR (US); Fabian Oboril, Karlsruhe (DE); Frederik Pasch, Karlesruhe (DE)

(21) Appl. No.: 18/146,218

(22) Filed: Dec. 23, 2022

(51) Int. Cl. G06N 5/022

(52) U.S. Cl. CPC G06N 5/022

(57) ABSTRACT

An apparatus, including: an interface operable to receive heat factor information for a geographic area; processing circuitry operable to: generate a digital twin of the geographic area, wherein the digital twin is a virtual representation of the geographic area, and based on the received heat factor information, spawns a heat distribution model that mirrors a heat distribution of the geographic area; and perform an action based on the heat distribution model.

### TECHNICAL FIELD

Aspects described herein generally relate to temperature management within a geographic area, and more particularly, to temperature management using a digital twin of the geographic area.

### BACKGROUND

Global warming is increasing environmental temperatures. Cities are impacted more than suburban areas because of the phenomenon of urban heat islands. Also, there are areas where temperature are colder than others as a result of global warming and climate change.

FIG. 1 illustrates a schematic diagram of a city 100 showing effects of heat islands. These effects include solar radiation absorption by low reflectance surfaces and trapping 11, insulated surfaces during high daytime temperatures 12, impermeable surfaces 13, obstructed sky view with trapped radiation heat 14, irrigation of select surfaces 15, anthropogenic heat, humidity, and pollutants 16, winds slowed and turbulence increased 17, and increased stored heat due to thermal properties and surface area 18, for example.

Increasing heat within a geographic area limits quality of life, reduces productivity, and increases heat-related deaths. Possible countermeasures to the increased heat include architectural changes, such as increasing the number of green parks, trees, and water, and adding vegetation to roofs or walls of buildings. It is also possible to change building shapes to increase air flow through the city. Besides general air temperature and sun light, other contributors to increasing heat include heat created by cars, air conditioners, and other heat-emitting devices. A majority of cities today are not prepared for the effects of global warming. Heat is not the only problem. Cold weather has also affected many areas which causes power outage, death, and resource constraints due to lack of energy source.

### BRIEF DESCRIPTION OF THE DRAWINGS

FIG. 1 illustrates a schematic diagram of a city showing effects of heat islands.

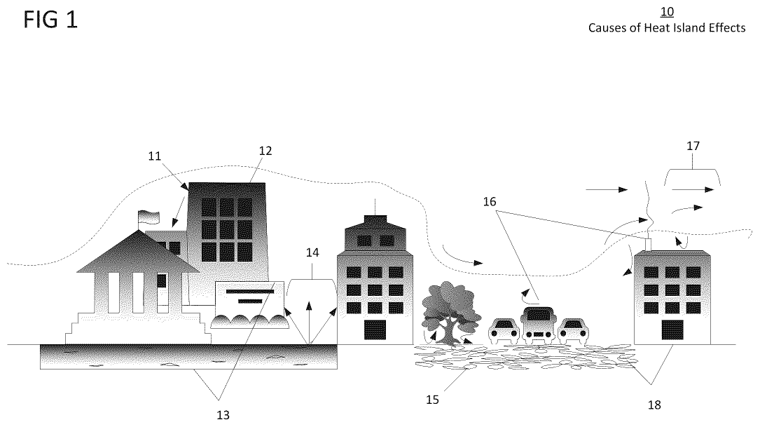

FIG. 2 illustrates a digital twin as a grid of cells representing environmental temperature states.

FIG. 3 illustrates a block diagram of heat distribution modeling in accordance with aspects of the disclosure.

FIG. 4 illustrates a block diagram of a heat or cold distribution simulation in accordance with aspects of the disclosure.

FIG. 5 illustrates a block diagram of cell priority determination in accordance with aspects of the disclosure.

FIG. 6 illustrates a block diagram of cell similarity determination in accordance with aspects of the disclosure.

FIG. 7A is a block diagram of heat/cold-aware guidance and heat/cold-informed navigation system 700A in accordance with aspects of the disclosure.

FIG. 7B illustrates a map of heat-aware guidance and heat-informed navigation in accordance with aspects of the disclosure.

FIG. 8 illustrates a block diagram of a computing device 800 in accordance with aspects of the disclosure.

### DESCRIPTION OF THE ASPECTS

The present disclosure is directed to generation of a digital twin of heat or cold distribution within a geographic area, such as a city. The digital twin spawns a heat or cold distribution model that mirrors a heat or cold distribution of the city, and may be used to optimize city architecture to decrease general heat or cold stress in particular areas. It is also possible to simulate and control active measurements to control the heat or cold within the city and countermeasure heat or cold stress. Also, heat/cold-reduced passages may be established through the city to reduce heat or cold exposure for pedestrians and bicyclists traversing the city.

### I. Digital Twin

A digital twin of is a virtual representation of the geographic area. Based on heat or cold factor information to estimate, record, and predict heat or cold distribution, the digital twin spawns a heat or cold distribution model that mirrors a heat or cold distribution of the geographic area. The digital twin may be a three-dimensional model including details such as building shapes, parks, vegetation, materials, and heat reflectivity. In addition, the digital twin may include temperature or wind sensor information, and other factors, including actual temperatures such as that of building walls and road surfaces. The information may also include heat emitters, such as traffic density air conditioner locations, perhaps with actual power consumption and/or heat emission information.

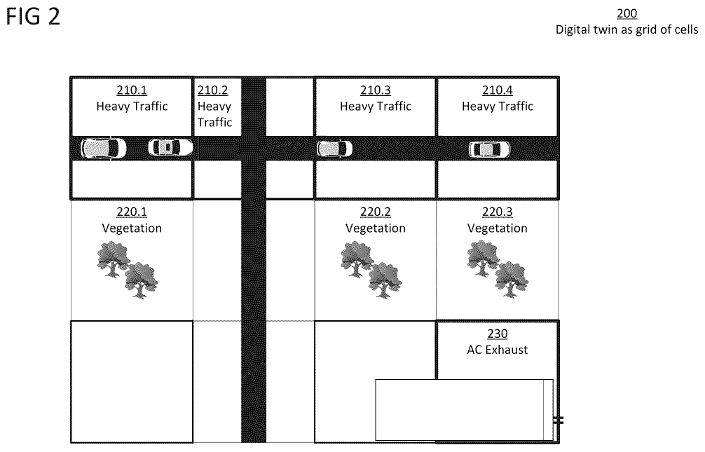

FIG. 2 illustrates a digital twin in a form of a grid of cells 200 representing environmental temperature states.

There are different ways to represent a temperature state. One possibility is to use hierarchical grids, where finer level cells represent a size of a few meters to capture single blocks or even buildings, and each cell includes a data value. These data values may include basic weather information such as current temperature, sun intensity, altitude of the sun, wind direction and force, precipitation (e.g., rain, snow, etc.) and cloud coverage. Furthermore, each cell may include information about buildings, such as building density, types of buildings, and how the buildings are arranged. Indicators on vegetation 220 (220.1-220.3), water surfaces, and reflectivity of surfaces may also be included. There may also be information about the traffic density 210 (210.1-210.4), other heat/cold sources (e.g., air conditioners 230 and heating exhausts), and heat/cold sinks. If a more accurate model is desired, grids can also be expanded into three dimensions. Arbitrary shapes and meshes are also possible.

This environmental information within the grid of cells 200 may be abstracted at coarser levels. When performing the abstraction, cell neighborhood relations are taken into consideration to maintain aggregate level information representing the resolution tiles having a balanced heating/cooling effect. This can be accomplished using Octree data structures, for example.

### II. Heat Distribution Modelling

Different ways of predicting how temperature builds within a single cell and across multiple cells of a grid are known. Based on a current temperature state for each cell, existing systems predict future temperature states using artificial intelligence (AI) (or machine learning) prediction models that receive cell value data in combination with weather forecasts. These models are trained using historic temperature states and their development. Historic data can be obtained from a lookup table when predicting future temperature states. The computational resources are relatively small, but a relatively large amount of data is required for accurate prediction results.

Other existing systems use CFD (computational fluid dynamics) simulation to predict future temperature states given heating and cooling sources in different cells at a particular time. Simulation is computationally expensive and time consuming. Thus, CFD is recommended for smaller grid sizes, and where sensor information is not sufficiently available to precisely model temperature.

The heat or cold distribution model spawned by the digital twin may be used to perform an action, such as predict a future heat/cold distribution of the geographic area, generate a recommendation for a countermeasure to reduce or increase a temperature within the geographic area, generate a heat/cold-optimized travel path for a user within the geographic area, or estimate a heat/cold risk of a user based on a constitution of the user. These actions are described in detail below.

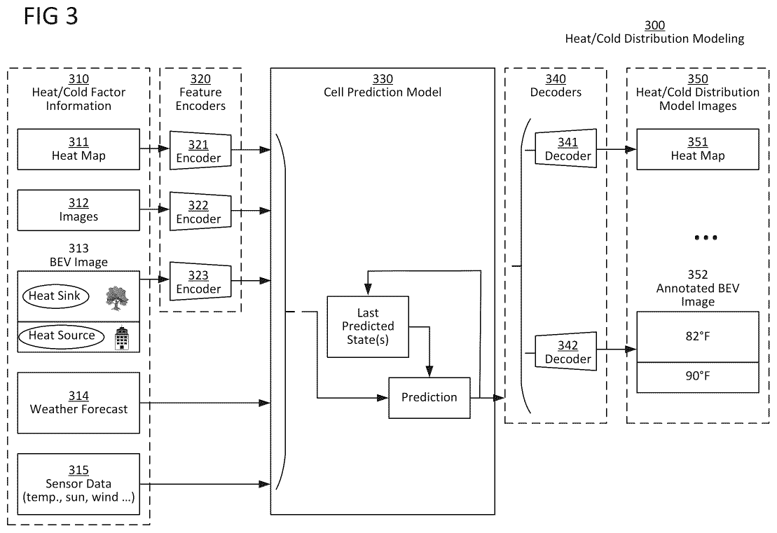

FIG. 3 illustrates a block diagram of heat distribution modeling 300 in accordance with aspects of the disclosure.

The heat distribution modeling 300 comprises heat/cold factor information 310, feature encoders 320, a cell prediction model 330, decoders 340, and heat/cold distribution model images 350.

The heat/cold factor information 310 for the respective cells includes one or more of a heat/cold map 311, images (e.g., buildings) 312, a bird-eye-view (BEV) image 313 (with heat/cold sources/sinks), weather forecast 314, and sensor data 315 (e.g. temperature, sun, wind, etc.).

The feature encoders 320 (321, 322, 323) process the heat/cold map 311, images 312, and BEV image 313 to output feature information. The feature encoders 320 may be convolutional neural networks (CNNs), for example. The images 312 have object geometries (e.g., of a building or road structure). The images themselves may be colored images to provide texture information (e.g., dark vs. bright surfaces). Further, the images may include locations of sensors (e.g., temperature, wind, and/or sun intensity sensors). The BEV image 313 has potential heat sinks (e.g., trees, lakes, etc.) potential heat sources (e.g., road, AC exhaust, etc.), potential cold sources, and potential cold sinks. These heat/cold sinks/sources could also be cell boundaries to indicate that heat/cold is transported into, or coming from, another cell.

The cell prediction model 330 may be a LSTM (Long-Short Term Memory) network that receives one or more of the features from the feature encoders 320, and the weather forecast 314 and sensor data 315, as input. The disclosure is not limited to the cell prediction model being the LSTM network 330. Other networks, such as a transformer networks, may be used. The cell prediction model 330 uses the features from the feature encoders 320, along with a weather forecast 314 and sensor data 315 as input data to predict temperature.

From the model's temperature predictions, the decoders 340 (341, 342) generate heat/cold distribution model images 350 as output representations. Examples of the heat/cold distribution model images 350 include a heat/cold map 351 and an annotated BEV image 352. The annotated BEV image 352 may be as simple as temperature values for different regions in the image, as illustrated. Of course output representations in forms other than images are possible.

To perform the prediction, the cell prediction model 330 keeps track of a time-series of prior predictions, which are internally combined with the heat/cold factor information 310, some of which is feature encoded. The heat/cold factor information 310 may be a time series, that is, a sequence of images with corresponding sensor data over the previous few hours with a particular sampling rate (e.g., one image every 15 minutes). Similarly, the heat/cold distribution model images 350 output may be a time series as well.

Training of the cell prediction model 330 is relatively simple. An unsupervised learning strategy may be employed by comparing the predicated output states with the measurements for the given time. This means that the cell prediction model 330 is trained automatically in the field. Of course the disclosure in not limited to this particular type of training.

Each cell might have a unique cell prediction model 330, though this would result in potentially high storage demands. Alternatively, the digital twin may spawn different cell prediction models 330 for different cells. To up-level the cell-wise predictions to coarser levels, the different predictions may be fused using a Kalman Filter, or a BEV-LSTM model, where cells act as heat/cold sinks/sources.

### III. Heat/cold Distribution Simulation

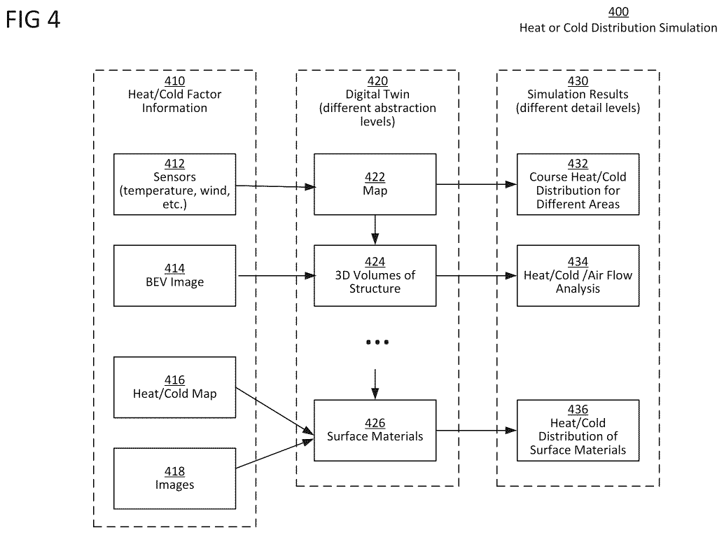

FIG. 4 illustrates a flow diagram of a heat/cold distribution simulation 400 in accordance with aspects of the disclosure.

The heat/cold distribution simulation 400 uses heat/cold factor information 410 (e.g., sensors 412, BEV image 414, heat/cold map 416, images 418, etc.), which is input to a digital twin 420, and outputs simulation results 430.

The heat/cold distribution simulation 400 may use different levels of abstract for the digital twin 420, for example, a simple map 422 to simulate a course distribution of the heat/cold, a three-dimensional structural volume 424, surface materials 426, etc. The simulation results 430 of the abstraction levels of the digital twin 420 result in different levels of detail of the simulation results 430. More specifically, the simple map 422 may result in course heat/cold distributions for different areas 432, the three-dimensional structural volumes 424 may result in a heat/cold/air flow analysis 434, and the surface materials 426 may result in a heat/cold distribution of surface materials 436.

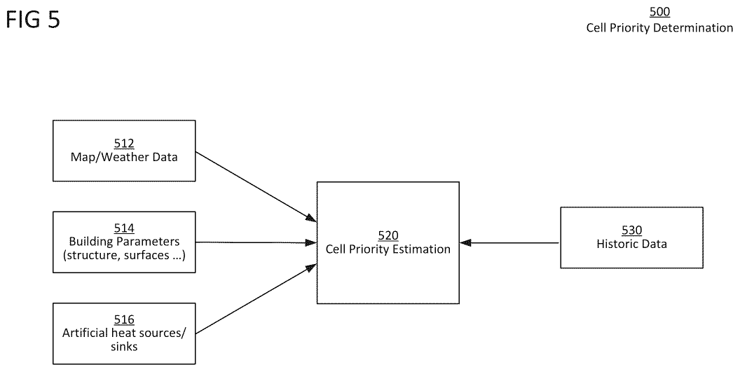

FIG. 5 illustrates a block diagram of cell priority determination 500 in accordance with aspects of the disclosure.

For larger geographic areas, adapting the abstraction level might not be sufficient to match the available computational resources. There are additional methods for scaling. A basic approach is to use data from maps and the weather forecast to determine a priority order of cells. This leads, for example, to prioritizing urban areas over rural areas, especially in hot weather conditions. Besides larger-scale effect, this approach might also have an impact on neighboring cells. For example, cells with a lot of vegetation (e.g., parks) next to a cell with a building would obtain a lower priority because dynamic changes due to heat or cold are much lower. In heat or cold waves, this approach might still not be sufficient as large areas might have the highest priority. Therefore, multiple layers of dynamic aspects may be taken into consideration.

Cell priority estimation 520 may be performed based on various layers of dynamic aspects. The illustrated layers of dynamic aspects shown include map/weather data 512, building parameters 514, artificial heat/cold sources/sinks 516, and historic data 530, but the disclosure is not limited to these particular layers.

The layer of building parameters 514 is the effect of local surfaces, the structure of buildings, and their arrangement on the weather. Sunshine duration, angle of the sun and resulting shadows, wind strength, and direction all have an effect on the cells, resulting in more complex dynamics. For example, dark surfaces tend to heat more quickly and thereby influence the environment more. Towards sunset the lower angle of the sun creates more shadows which might cool down the surroundings. The more variables, the higher a cell's priority.

The artificial heat/cold sources/sinks layer 516 incorporates artificial aspects such as traffic. If a cell has a high number of heat/cold sources/sinks, it receives a higher priority as it might have a high influence on the heat/cold distribution determination. As these aspects might change during a day, the priority might even change. For example, during rush hour with a lot of traffic in particular areas, the priority of particular cells increases. Also, the number of air conditionings for buildings within a cell might have an significant influence.

Further, the priority of cells may be rated by taking into account historic data 530. An estimation based on known data is performed, and the results are then compared to historic cell dynamics. If a significant mismatch is detected, meaning there are more influences than expected (e.g. hidden ACs), the cell is assigned a higher priority.

The cell priority estimation 520 takes into consideration the result of these approaches and returns a priority for each cell. The cell priority estimation 520 might even prioritize the results of certain approaches over others. Depending on the computational resources, a threshold would be defined to allow execution of the cell prioritization to a particular priority level.

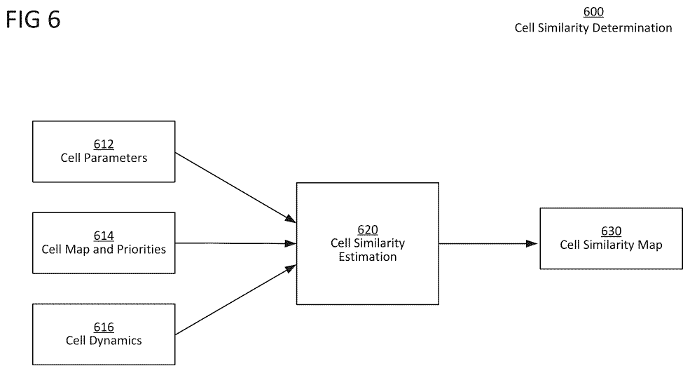

FIG. 6 illustrates a block diagram of cell similarity determination 600 in accordance with aspects of the disclosure.

A cell similarity estimation 620 is based on input information such as cell parameters 612, cell map and priorities 614, and/or cell dynamics 616. A result of the cell similarity estimation 620 may be a cell similarity map 630.

Due to constraints on computational resources, a larger number of cells might not be selected for calculation. This could result in inaccurate calculations on a larger scale. There are other possible approaches that are not applied on a single-cell level but on a higher level.

One additional approach is to group cells having heat/cold distributions that are impacted by the heat/cold factor information similarly, and perform a simulation of temperature change for one of the cells in the group, wherein a result of the simulation is applicable to each of the cells of the group. The simulation would need to be performed for the group only once. This is especially applicable for adjacent cells in a homogenous environment, but might also be applied to discontinuous cells that have similar characteristics. With enough historic data (e.g., several years to see the effect of the weather/seasons), this approach is well suited to significantly reduce calculation efforts while maintaining a specific precision level. As the environment might change over time (e.g., new building, changed traffic routing, climate change . . . ), this approach might result in a decrease in precision. However, there is an alternative approach.

In contrast to the static approach described in the previous paragraph, it is possible to group cells having heat/cold distributions that are impacted by the heat/cold factor information similarly in a dynamic manner based on updated received heat/cold factor information using a sampling approach. It is considered that during the evening (i.e., without the sun as significant heat source) the calculations may be reduced or even stopped. During that period, as the computational resources are available data that was captured during the day is getting processed, for example, the data of every hour of the last day. The cell dynamics, including the input parameters are compared to other cells, which leads to a cell similarity map 630 that may be used to group cells and reduce future calculations. As an extension, even the cell size might be changed dynamically to better cope with its dynamics.

Besides prediction, the heat/cold distribution simulation 400 has additional benefits, such as simulation of potential architectural changes, heat/cold countermeasures, heat/cold-aware guidance, and heat/code-informed navigation, to name a few.

### A. Simulation of Architectural Changes

The heat/cold distribution simulation 400 may be used to optimize urban architecture. The effects of modifications to the city model may be simulated. Also, heat/cold sources that contaminate other areas may be identified. It is also possible to train directly a system that may suggest countermeasures to reduce an average or peak heat/cold in the geographic area.

### B. Heat/cold Countermeasures

As actual architectural changes to cities require significant time and are not always possible, another advantage is that the digital twin may be used to suggest and control active countermeasures. The countermeasures could include, for example, active cooling of sidewalks/streets or even building walls.

Other countermeasures could be to restrict usage of heat emitting devices to specific times, such as to use air conditioners dependent on wind direction. If wind is carrying the emitted heat into the city, the air conditioner operation should be limited during the day and be operated primarily during the evening.

Further, it is possible to restrict traffic to certain geographic areas in order to reduce heat in specific areas. These specific areas could be, for example, areas where people want to walk outside (e.g., near pedestrian zones, schools, playgrounds and/ or elder care facilities).

### C. Heat/Cold-Aware Guidance and Heat/Cold-Informed Navigation

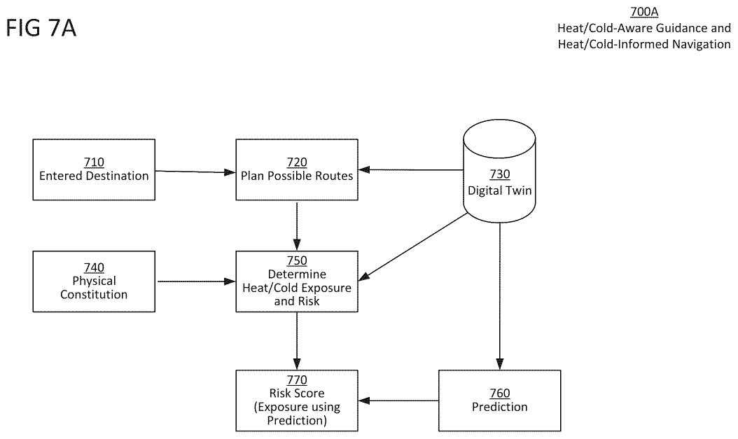

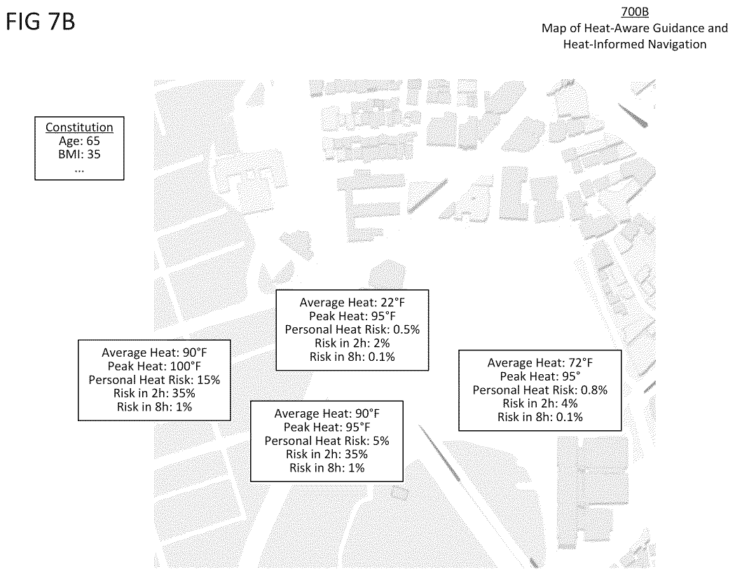

FIG. 7A is a block diagram of heat/cold-aware guidance and heat/cold-informed navigation system 700A in accordance with aspects of the disclosure. FIG. 7B illustrates a corresponding map 700B.

Besides the general monitoring and controlling of temperature within a geographic area, inhabitants could also benefit from knowledge of the heat/cold distribution information. Exposure to heat/cold is unpleasant, but for some people it could also become life-threatening.

A heat/cold informed navigation system 700A provides a service so people may find a traveling route that reduces heat/cold exposure. The service may also take a person's physical constitution 740 into account and advise whether it would be a health risk 750 for the person to take the trip. This information may be entered in a privacy-conforming manner without personal information stored. The system 700A uses a model that calculates the health risk of an individual given health indicators such as age, body mass index (BMI), etc. This information together with exposure duration and a walking distance is combined into a risk score 770 for individual routes.

In addition, system 700A accesses the digital twin 730 to request the current temperature state as well as future temperature states for the expected trip duration to the entered destination 710. As a result, the system 700A has detailed knowledge of shadow regions over the trip duration, as well as about regions that are cooler than others. Based on this information, multiple routes may be planned 720, some of which might even start in future. The user may be informed of the prediction 760 and how the risk will evolve over the next hours, enabling the user to have an option to delay the trip if the future risk is more favorable.

### D. Additional Services

The heat/cold distribution simulation 400 has additional applications, such as providing advice to inhabitants as to preferred times to open windows to cool residences. These approaches may also be used for weather conditions such as storms, floods, and/or snow/ice; this information would provide an indication about surfaces and heat/cold sources/sinks to identify areas that might become slippery due to water, either because of heavy rain or freezing water. For floods and storms, knowledge about building architecture could be used to calculate local wind speeds and the degree of damage the storm could cause to surrounding structures.

### IV. Computing Device

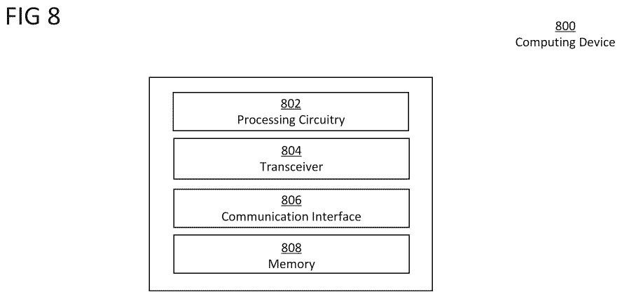

FIG. 8 illustrates a block diagram of a computing device 800 in accordance with aspects of the disclosure. The computing device 800 may be identified with a central controller and be implemented as any suitable network infrastructure component, which may be implemented as a cloud/edge network server, controller, computing device, etc. The computing device 800 may serve the heat/cold distribution modeling 300 and heat/cold distribution simulation 400 in accordance with the various techniques as discussed herein. To do so, the computing device 800 may include processing circuitry 802, a transceiver 804, communication interface 806, and a memory 808. The components shown in FIG. 8 are provided for ease of explanation, and the computing device 800 may implement additional, less, or alternative components as those shown in FIG. 8.

The processing circuitry 802 may be operable as any suitable number and/or type of computer processors, which may function to control the computing device 800. The processing circuitry 802 may be identified with one or more processors (or suitable portions thereof) implemented by the computing device 800. The processing circuitry 802 may be identified with one or more processors such as a host processor, a digital signal processor, one or more microprocessors, graphics processors, baseband processors, microcontrollers, an application-specific integrated circuit (ASIC), part (or the entirety of) a field-programmable gate array (FPGA), etc.

In any event, the processing circuitry 802 may be operable to carry out instructions to perform arithmetical, logical, and/or input/output (I/O) operations, and/or to control the operation of one or more components of computing device 800 to perform various functions as described herein. The processing circuitry 802 may include one or more microprocessor cores, memory registers, buffers, clocks, etc., and may generate electronic control signals associated with the components of the computing device 800 to control and/or modify the operation of these components. The processing circuitry 802 may communicate with and/or control functions associated with the transceiver 804, the communication interface 806, and/or the memory 808. The processing circuitry 802 may additionally perform various operations to control the communications, communications scheduling, and/or operation of other network infrastructure components that are communicatively coupled to the computing device 800.

The transceiver 804 may be implemented as any suitable number and/or type of components operable to transmit and/or receive data packets and/or wireless signals in accordance with any suitable number and/or type of communication protocols. The transceiver 804 may include any suitable type of components to facilitate this functionality, including components associated with known transceiver, transmitter, and/or receiver operation, configurations, and implementations. Although depicted in FIG. 8 as a transceiver, the transceiver 804 may include any suitable number of transmitters, receivers, or combinations of these that may be integrated into a single transceiver or as multiple transceivers or transceiver modules. The transceiver 804 may include components typically identified with a radio frequency (RF) front end and include, for example, antennas, ports, power amplifiers (PAs), RF filters, mixers, local oscillators (LOs), low noise amplifiers (LNAs), up-converters, down-converters, channel tuners, etc.

The communication interface 806 may be operable as any suitable number and/or type of components operable to facilitate the transceiver 804 receiving and/or transmitting data and/or signals in accordance with one or more communication protocols, as discussed herein. The communication interface 806 may be implemented as any suitable number and/or type of components that function to interface with the transceiver 804, such as analog-to-digital converters (ADCs), digital to analog converters, intermediate frequency (IF) amplifiers and/or filters, modulators, demodulators, baseband processors, etc. The communication interface 806 may thus work in conjunction with the transceiver 804 and form part of an overall communication circuitry implemented by the computing device 800, which may be implemented via the computing device 800 to transmit commands and/or control signals to execute any of the functions describe herein.

The memory 808 is operable to store data and/or instructions such that, when the instructions are executed by the processing circuitry 802, cause the computing device 800 to perform various functions as described herein. The memory 808 may be implemented as any well-known volatile and/or non-volatile memory, including, for example, read-only memory (ROM), random access memory (RAM), flash memory, a magnetic storage media, an optical disc, erasable programmable read only memory (EPROM), programmable read only memory (PROM), etc. The memory 808 may be non-removable, removable, or a combination of both. The memory 808 may be implemented as a non-transitory computer readable medium storing one or more executable instructions such as, for example, logic, algorithms, code, etc.

As further discussed below, the instructions, logic, code, etc., stored in the memory 808 are represented by the various modules/engines as shown in FIG. 8. Alternatively, if implemented via hardware, the modules/engines shown in FIG. 8 associated with the memory 808 may include instructions and/or code to facilitate control and/or monitor the operation of such hardware components. In other words, the modules/engines as shown in FIG. 8 are provided for ease of explanation regarding the functional association between hardware and software components. Thus, the processing circuitry 802 may execute the instructions stored in these respective modules/engines in conjunction with one or more hardware components to perform the various functions as discussed herein.

### V. Artificial Intelligence/Machine Learning

Various aspects described herein may utilize one or more machine learning models to generate a heat/cold distribution modelling 300 or perform a heat/cold distribution simulation 400. The term “model” as, for example, used herein may be understood as any kind of algorithm, which provides output data from input data (e.g., any kind of algorithm generating or calculating output data from input data). A machine learning model may be executed by a computing system to progressively improve performance of a specific task. In some aspects, parameters of a machine learning model may be adjusted during a training phase based on training data. A trained machine learning model may be used during an inference phase to make predictions or decisions based on input data. In some aspects, the trained machine learning model may be used to generate additional training data. An additional machine learning model may be adjusted during a second training phase based on the generated additional training data. A trained additional machine learning model may be used during an inference phase to make predictions or decisions based on input data.

The machine learning models described herein may take any suitable form or utilize any suitable technique (e.g., for training purposes). For example, any of the machine learning models may utilize supervised learning, semi-supervised learning, unsupervised learning, or reinforcement learning techniques.

In supervised learning, the model may be built using a training set of data including both the inputs and the corresponding desired outputs (illustratively, each input may be associated with a desired or expected output for that input). Each training instance may include one or more inputs and a desired output. Training may include iterating through training instances and using an objective function to teach the model to predict the output for new inputs (illustratively, for inputs not included in the training set). In semi-supervised learning, a portion of the inputs in the training set may be missing the respective desired outputs (e.g., one or more inputs may not be associated with any desired or expected output).

In unsupervised learning, the model may be built from a training set of data including only inputs and no desired outputs. The unsupervised model may be used to find structure in the data (e.g., grouping or clustering of data points), illustratively, by discovering patterns in the data. Techniques that may be implemented in an unsupervised learning model may include, e.g., self-organizing maps, nearest-neighbor mapping, k-means clustering, and singular value decomposition.

Reinforcement learning models may include positive or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

Various aspects described herein may utilize one or more classification models. In a classification model, the outputs may be restricted to a limited set of values (e.g., one or more classes). The classification model may output a class for an input set of one or more input values. An input set may include sensor data, such as image data, radar data, LIDAR data and the like. A classification model as described herein may, for example, classify certain driving conditions and/or environmental conditions, such as weather conditions, road conditions, and the like. References herein to classification models may contemplate a model that implements, e.g., any one or more of the following techniques: linear classifiers (e.g., logistic regression or naive Bayes classifier), support vector machines, decision trees, boosted trees, random forest, neural networks, or nearest neighbor.

Various aspects described herein may utilize one or more regression models. A regression model may output a numerical value from a continuous range based on an input set of one or more values (illustratively, starting from or using an input set of one or more values). References herein to regression models may contemplate a model that implements, e.g., any one or more of the following techniques (or other suitable techniques): linear regression, decision trees, random forest, or neural networks.

A machine learning model described herein may be or may include a neural network. The neural network may be any kind of neural network, such as a convolutional neural network, an autoencoder network, a variational autoencoder network, a sparse autoencoder network, a recurrent neural network, a deconvolutional network, a generative adversarial network, a forward thinking neural network, a sum-product neural network, and the like. The neural network may include any number of layers. The training of the neural network (e.g., adapting the layers of the neural network) may use or may be based on any kind of training principle, such as backpropagation (e.g., using the backpropagation algorithm).

The techniques of this disclosure may also be described in the following examples.

Example 1. An apparatus for temperature management, comprising: an interface operable to receive heat or cold factor information for a geographic area; processing circuitry operable to: generate a digital twin of the geographic area, wherein the digital twin is a virtual representation of the geographic area, and based on the received heat or cold factor information, spawns a heat or cold distribution model that mirrors a heat or cold distribution of the geographic area; and perform an action based on the heat or cold distribution model.

Example 2. The apparatus of example 1, wherein the processing circuitry is further operable to: generate the digital twin as a three-dimensional digital twin; and predict a future heat or cold distribution of the geographic area as the action to perform.

Example 3. The apparatus of any one or more of examples 1-2, wherein the processing circuitry is further operable to: generate a recommendation for a countermeasure to reduce or increase a temperature within the geographic area as the action to perform.

Example 4. The apparatus of any one or more of examples 1-3, wherein the processing circuitry is further operable to: generate, based on the heat or cold distribution model, a heat/cold-optimized travel path for a user within the geographic area as the action to perform.

Example 5. The apparatus of any one or more of examples 1-4, wherein the processing circuitry is further operable to: estimate a heat or cold risk of a user based on a constitution of the user as the action to perform.

Example 6. The apparatus of any one or more of examples 1-5, wherein the received heat or cold factor information comprises a heat source, a cold source, a heat sink, or a cold sink within the geographic area.

Example 7. The apparatus of any one or more of examples 1-6, wherein the processing circuitry is further operable to: generate the digital twin of the geographic area as a grid of cells, wherein each of the cells includes a data value related to the received heat or cold factor information.

Example 8. The apparatus of any one or more of examples 1-7, wherein the heat or cold factor information comprises weather, building density, building type, building arrangement, HVAC (heating, ventilation, and air conditioning), vegetation, water, surface reflectivity, or traffic density information.

Example 9. The apparatus of any one or more of examples 1-8, wherein the processing circuitry is further operable to: generate the digital twin of the geographic area as a grid of cells; and determine a priority order of the cells for a temperature change simulation based on a significance of the heat or cold factor information on heat distribution within the cells.

Example 10. The apparatus of any one or more of examples 1-9, wherein the processing circuitry is further operable to: generate the digital twin of the geographic area as a grid of cells; forming a group of any of the cells having heat or cold distributions that are impacted by the heat or cold factor information similarly; and perform a simulation of temperature change for one of the cells in the group, wherein a result of the simulation is applicable to each of the cells of the group.

Example 11. The apparatus of any one or more of examples 1-10, wherein the processing circuitry is further operable to: dynamically group any of the cells having heat or cold distributions that are impacted by the heat or cold factor information similarly based on updated received heat or cold factor information.

Example 12. The apparatus of any one or more of examples 1-11, wherein the processing circuitry is further operable to: provide, as the performed action, an image of the heat or cold distribution model, wherein the image comprises a heat or cold distribution map, a heat or cold flow map, or an air flow map of the geographic area.

Example 13. The apparatus of any one or more of examples 1-2, wherein the processing circuitry is further operable to: generate the digital twin of the geographic area as a grid of cells; and for at least two of the cells, spawn different heat or cold distribution models.

Example 14. The apparatus of any one or more of examples 1-13, wherein: at least a portion of the heat factor information is received from a sensor located in the geographic area; and the heat or cold distribution model comprises an actual temperature of a location within the geographic area.

Example 15. A component of a system for temperature management, comprising: processing circuitry; and a non-transitory computer-readable storage medium including instructions that, when executed by the processing circuitry, cause the processing circuitry to: generate a digital twin of a geographic area, wherein the digital twin is a virtual representation of the geographic area; based on received heat or cold factor information of the geographic area, spawn a heat or cold distribution model that mirrors a heat or cold distribution of the geographic area; and perform an action based on the heat or cold distribution model.

Example 16. The component of example 15, wherein the instructions further cause the processing circuitry to: generate the digital twin as a three-dimensional digital twin; and predict a future heat or cold distribution of the geographic area as the action to perform.

Example 17. The component of any one or more of examples 15-16, wherein the instructions further cause the processing circuitry to: generate a recommendation for a countermeasure to reduce a temperature within the geographic area as the action to perform.

Example 18. The component of any one or more of examples 15-17, wherein the instructions further cause the processing circuitry to: generate, based on the heat or cold distribution model, a heat-optimized travel path for a user within the geographic area as the action to perform.

Example 19. The component of any one or more of examples 15-18, wherein the instructions further cause the processing circuitry to: estimate a heat or cold risk of a user based on a constitution of the user as the action to perform.

Example 20. The component of any one or more of examples 15-19, wherein the received heat or cold factor information comprises a heat or cold source or a heat or cold sink within the geographic area.

Example 21. The component of any one or more of examples 15-20, wherein the instructions further cause the processing circuitry to: generate the digital twin of the geographic area as a grid of cells, wherein each of the cells includes a data value related to the received heat or cold factor information.

Example 22. The component of any one or more of examples 15-21, wherein the instructions further cause the processing circuitry to: generate the digital twin of the geographic area as a grid of cells; and determine a priority order of the cells for a temperature change simulation based on a significance of the heat or cold factor information on heat or cold distribution within the cells.

Example 23. The component of any one or more of examples 15-22, wherein the instructions further cause the processing circuitry to: generate the digital twin of the geographic area as a grid of cells; form a group of any of the cells having heat distributions that are impacted by the heat or cold factor information similarly; and perform a simulation of temperature change for one of the cells in the group, wherein a result of the simulation is applicable to each of the cells of the group.

Example 24. The component of any one or more of examples 15-23, wherein the instructions further cause the processing circuitry to: provide an image of the heat or cold distribution model, wherein the image comprises a heat or cold distribution map, a heat or cold flow map, or an air flow map of the geographic area as the action to perform.

Example 25. The component of any one or more of examples 15-24, wherein: at least a portion of the heat or cold factor information is received from a sensor located in the geographic area; and the heat or cold distribution model comprises an actual temperature of a location within the geographic area.

Example 26. An apparatus for temperature management, comprising: an interface means for receiving heat or cold factor information for a geographic area; processing means for: generating a digital twin of the geographic area, wherein the digital twin is a virtual representation of the geographic area, and based on the received heat or cold factor information, spawning a heat or cold distribution model that mirrors a heat or cold distribution of the geographic area; and performing an action based on the heat or cold distribution model.

Example 27. The apparatus of example 26, wherein the processing means is further for: generating the digital twin as a three-dimensional digital twin; and predicting a future heat or cold distribution of the geographic area as the action to perform.

Example 18. The apparatus of any one or more of examples 26-27, wherein the processing means is further for: generating a recommendation for a countermeasure to reduce or increase a temperature within the geographic area as the action to perform.

Example 29. The apparatus of any one or more of examples 26-28, wherein the processing means is further for: generating, based on the heat or cold distribution model, a heat/cold-optimized travel path for a user within the geographic area as the action to perform.

Example 30. The apparatus of any one or more of examples 26-29, wherein the processing means is further for: estimating a heat or cold risk of a user based on a constitution of the user as the action to perform.

Example 31. The apparatus of any one or more of examples 26-20, wherein the received heat or cold factor information comprises a heat source, a cold source, a heat sink, or a cold sink within the geographic area.

Example 32. The apparatus of any one or more of examples 26-31, wherein the processing means is further for: generating the digital twin of the geographic area as a grid of cells, wherein each of the cells includes a data value related to the received heat or cold factor information.

Example 33. The apparatus of any one or more of examples 26-32, wherein the heat or cold factor information comprises weather, building density, building type, building arrangement, HVAC (heating, ventilation, and air conditioning), vegetation, water, surface reflectivity, or traffic density information.

Example 34. The apparatus of any one or more of examples 26-33, wherein the processing means is further for: generating the digital twin of the geographic area as a grid of cells; and determining a priority order of the cells for a temperature change simulation based on a significance of the heat or cold factor information on heat distribution within the cells.

Example 35. The apparatus of any one or more of examples 26-34, wherein the processing means is further for: generating the digital twin of the geographic area as a grid of cells; forming a group of any of the cells having heat or cold distributions that are impacted by the heat or cold factor information similarly; and performing a simulation of temperature change for one of the cells in the group, wherein a result of the simulation is applicable to each of the cells of the group.

Example 36. The apparatus of any one or more of examples 26-356, wherein the processing means is further for: dynamically grouping any of the cells having heat or cold distributions that are impacted by the heat or cold factor information similarly based on updated received heat or cold factor information.

Example 37. The apparatus of any one or more of examples 26-36, wherein the processing means is further for: providing, as the performed action, an image of the heat or cold distribution model, wherein the image comprises a heat or cold distribution map, a heat or cold flow map, or an air flow map of the geographic area.

Example 38. The apparatus of any one or more of examples 26-37, wherein the processing means is further for: generating the digital twin of the geographic area as a grid of cells; and for at least two of the cells, spawning different heat or cold distribution models.

Example 39. The apparatus of any one or more of examples 26-38, wherein: at least a portion of the heat factor information is received from a sensor located in the geographic area; and the heat or cold distribution model comprises an actual temperature of a location within the geographic area.

Example 40. A component of a system for temperature management, comprising: processing means; and a non-transitory computer-readable storage medium including instructions that, when executed by the processing means, cause the processing means to: generate a digital twin of a geographic area, wherein the digital twin is a virtual representation of the geographic area; based on received heat or cold factor information of the geographic area, spawn a heat or cold distribution model that mirrors a heat or cold distribution of the geographic area; and perform an action based on the heat or cold distribution model.

Example 41. The component of example 40, wherein the instructions further cause the processing means to: generate the digital twin as a three-dimensional digital twin; and predict a future heat or cold distribution of the geographic area as the action to perform.

Example 42. The component of any one or more of examples 40-41, wherein the instructions further cause the processing means to: generate a recommendation for a countermeasure to reduce a temperature within the geographic area as the action to perform.

Example 43. The component of any one or more of examples 40-42, wherein the instructions further cause the processing means to: generate, based on the heat or cold distribution model, a heat-optimized travel path for a user within the geographic area as the action to perform.

Example 44. The component of any one or more of examples 40-43, wherein the instructions further cause the processing means to: estimate a heat or cold risk of a user based on a constitution of the user as the action to perform.

Example 45. The component of any one or more of examples 40-44, wherein the received heat or cold factor information comprises a heat or cold source or a heat or cold sink within the geographic area.

Example 46. The component of any one or more of examples 40-45, wherein the instructions further cause the processing means to: generate the digital twin of the geographic area as a grid of cells, wherein each of the cells includes a data value related to the received heat or cold factor information.

Example 47. The component of any one or more of examples 40-46, wherein the instructions further cause the processing means to: generate the digital twin of the geographic area as a grid of cells; and determine a priority order of the cells for a temperature change simulation based on a significance of the heat or cold factor information on heat or cold distribution within the cells.

Example 48. The component of any one or more of examples 40-47, wherein the instructions further cause the processing means to: generate the digital twin of the geographic area as a grid of cells; form a group of any of the cells having heat distributions that are impacted by the heat or cold factor information similarly; and perform a simulation of temperature change for one of the cells in the group, wherein a result of the simulation is applicable to each of the cells of the group.

Example 49. The component of any one or more of examples 40-48, wherein the instructions further cause the processing means to: provide an image of the heat or cold distribution model, wherein the image comprises a heat or cold distribution map, a heat or cold flow map, or an air flow map of the geographic area as the action to perform.

Example 50. The component of any one or more of examples 40-49, wherein: at least a portion of the heat or cold factor information is received from a sensor located in the geographic area; and the heat or cold distribution model comprises an actual temperature of a location within the geographic area.

While the foregoing has been described in conjunction with exemplary aspect, it is understood that the term “exemplary” is merely meant as an example, rather than the best or optimal. Accordingly, the disclosure is intended to cover alternatives, modifications and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1. An apparatus for temperature management, comprising:
an interface operable to receive heat or cold factor information for a geographic area;
processing circuitry operable to:
generate a digital twin of the geographic area, wherein the digital twin is a virtual representation of the geographic area, and based on the received heat or cold factor information, spawns a heat or cold distribution model that mirrors a heat or cold distribution of the geographic area; and
perform an action based on the heat or cold distribution model.

2. The apparatus of claim 1, wherein the processing circuitry is further operable to:
generate the digital twin as a three-dimensional digital twin; and
predict a future heat or cold distribution of the geographic area as the action to perform.

3. The apparatus of claim 1, wherein the processing circuitry is further operable to:
generate a recommendation for a countermeasure to reduce or increase a temperature within the geographic area as the action to perform.

4. The apparatus of claim 1, wherein the processing circuitry is further operable to:
generate, based on the heat or cold distribution model, a heat-optimized or cold-optimized travel path for a user within the geographic area as the action to perform.

5. The apparatus of claim 1, wherein the processing circuitry is further operable to:
estimate a heat or cold risk of a user based on a constitution of the user as the action to perform.

6. The apparatus of claim 1, wherein the received heat or cold factor information comprises a heat source, a cold source, a heat sink, or a cold sink within the geographic area.

7. The apparatus of claim 1, wherein the processing circuitry is further operable to:
generate the digital twin of the geographic area as a grid of cells,
wherein each of the cells includes a data value related to the received heat or cold factor information.

8. The apparatus of claim 7, wherein the heat or cold factor information comprises weather, building density, building type, building arrangement, HVAC (heating, ventilation, and air conditioning), vegetation, water, surface reflectivity, or traffic density information.

9. The apparatus of claim 1, wherein the processing circuitry is further operable to:
generate the digital twin of the geographic area as a grid of cells; and
determine a priority order of the cells for a temperature change simulation based on a significance of the heat or cold factor information on heat distribution within the cells.

10. The apparatus of claim 1, wherein the processing circuitry is further operable to:
generate the digital twin of the geographic area as a grid of cells;
forming a group of any of the cells having heat or cold distributions that are impacted by the heat or cold factor information similarly; and
perform a simulation of temperature change for one of the cells in the group, wherein a result of the simulation is applicable to each of the cells of the group.

11. The apparatus of claim 10, wherein the processing circuitry is further operable to:
dynamically group any of the cells having heat or cold distributions that are impacted by the heat or cold factor information similarly based on updated received heat or cold factor information.

12. The apparatus of claim 1, wherein the processing circuitry is further operable to:
provide, as the performed action, an image of the heat or cold distribution model, wherein the image comprises a heat or cold distribution map, a heat or cold flow map, or an air flow map of the geographic area.

13. The apparatus of claim 1, wherein the processing circuitry is further operable to:
generate the digital twin of the geographic area as a grid of cells; and
for at least two of the cells, spawn different heat or cold distribution models.

14. The apparatus of claim 1, wherein:
at least a portion of the heat factor information is received from a sensor located in the geographic area; and
the heat or cold distribution model comprises an actual temperature of a location within the geographic area.

15. A component of a system for temperature management, comprising:
processing circuitry; and
a non-transitory computer-readable storage medium including instructions that, when executed by the processing circuitry, cause the processing circuitry to:
generate a digital twin of a geographic area, wherein the digital twin is a virtual representation of the geographic area;
based on received heat or cold factor information of the geographic area, spawn a heat or cold distribution model that mirrors a heat or cold distribution of the geographic area; and
perform an action based on the heat or cold distribution model.

16. The component of claim 15, wherein the instructions further cause the processing circuitry to:
generate the digital twin as a three-dimensional digital twin; and
predict a future heat or cold distribution of the geographic area as the action to perform.

17. The component of claim 15, wherein the instructions further cause the processing circuitry to:
generate a recommendation for a countermeasure to reduce a temperature within the geographic area as the action to perform.

18. The component of claim 15, wherein the instructions further cause the processing circuitry to:
generate, based on the heat or cold distribution model, a heat-optimized travel path for a user within the geographic area as the action to perform.

19. The component of claim 15, wherein the instructions further cause the processing circuitry to:
estimate a heat or cold risk of a user based on a constitution of the user as the action to perform.

20. The component of claim 15, wherein the received heat or cold factor information comprises a heat or cold source or a heat or cold sink within the geographic area.

21. The component of claim 15, wherein the instructions further cause the processing circuitry to:
generate the digital twin of the geographic area as a grid of cells,
wherein each of the cells includes a data value related to the received heat or cold factor information.

22. The component of claim 15, wherein the instructions further cause the processing circuitry to:
generate the digital twin of the geographic area as a grid of cells; and
determine a priority order of the cells for a temperature change simulation based on a significance of the heat or cold factor information on heat or cold distribution within the cells.

23. The component of claim 15, wherein the instructions further cause the processing circuitry to:
generate the digital twin of the geographic area as a grid of cells;
form a group of any of the cells having heat distributions that are impacted by the heat or cold factor information similarly; and
perform a simulation of temperature change for one of the cells in the group, wherein a result of the simulation is applicable to each of the cells of the group.

24. The component of claim 15, wherein the instructions further cause the processing circuitry to:
provide an image of the heat or cold distribution model, wherein the image comprises a heat or cold distribution map, a heat or cold flow map, or an air flow map of the geographic area as the action to perform.

25. The component of claim 15, wherein:
at least a portion of the heat or cold factor information is received from a sensor located in the geographic area; and
the heat or cold distribution model comprises an actual temperature of a location within the geographic area.
